(19) United States
(12) Patent Application Publication
(10) Pub. No.: US 2016/0222319 A1
(43) Pub. Date: Aug. 4, 2016

(54) A STAIN TREATMENT ADDITIVE

(71) Applicant: CRODA INTERNATIONAL PLC, Goole Yorkshire (GB)

(72) Inventors: MAHZAD GOODWIN, BROUGH YORKSHIRE (GB); Peter MURPHY, GOOLE YORKSHIRE (GB); SUZANNE BURN LEES, LEEDS YORKSHIRE (GB)

(73) Assignee: CRODA INTERNATIONAL PLC, GOOLE YORKSHIRE (GB)

(21) Appl. No.: 15/021,481

(22) PCT Filed: Sep. 8, 2014
(86) PCT No.: PCT/GB2014/052708

§ 371 Date: Mar. 11, 2016

(30) Foreign Application Priority Data
Sep. 19, 2013 (GB) 1316619.4

(51) Int. Cl. C11D 3/20; C11D 1/83; C11D 1/22; C11D 1/12; C11D 11/00; C11D 1/66

(52) U.S. Cl. CPC C11D 3/2068; C11D 11/0017; C11D 3/2079; C11D 1/662; C11D 1/22; C11D 1/12; C11D 1/83

(57) ABSTRACT

The present invention provides a stain treatment additive which comprises an ester of glycerol and/or polyglycerol and a C12 to C30 fatty acid, wherein the glycerol and/or polyglycerol has been alkoxylated with up to 30 mols of an alkylene oxide and its use in a textile cleaning composition, a laundry detergent composition, a stain remover composition and a method of cleaning a textile.

The present invention relates to a stain treatment additive and its use in a textile cleaning composition, a laundry detergent composition and a stain remover composition, a method of cleaning textiles by applying the stain treatment additive to the textile and the use of the stain treatment additive to clean textiles.

The removal of stains from fabrics is a known problem in textile cleaning. While the use of known textile cleaning compositions and detergents has proven successful for cleaning a wide variety of stains, the removal of oily, fatty or particulate stains is often troublesome insofar as such compositions do not generally contain a solvent suited for oil solubilization. Known compositions which are specifically formulated for oily stain removal may be impractical to use, or may not provide satisfactory results.

The present invention seeks to improve the removal of stains from textiles, for example, oil based stains.

The present invention is based in part on the recognition by the applicant that the application to a textile of a stain treatment additive comprising an ester of glycerol and/or polyglycerol and a C₁₂ to C₃₀ fatty acid, wherein the glycerol and/or polyglycerol has been alkoxylated with up to 30 mols of an alkylene oxide may be effective in removing one or more types of stain from the textile.

Thus viewed from one aspect the present invention provides a textile cleaning composition comprising:
at least 0.2 wt % of a stain treatment additive, wherein the stain treatment additive comprises an ester of glycerol and/or polyglycerol and a C₁₂ to C₃₀ fatty acid, wherein the glycerol and/or polyglycerol has been alkoxylated with up to 30 mols of an alkylene oxide; and
at least 10 wt % in total of one or more surfactants or mixtures thereof, not including the stain treatment additive.

Without being bound by theory, it is believed that the balance between the chain length of the fatty acid (generally hydrophobic) portion and the amount of the alkylene oxide (generally hydrophilic) portion included in the stain treatment additive may allow the stain treatment additive to have some degree of solubility in water while also retaining enough solubility in oil and grease to have a greater ability to dissolve stains such as oily or fatty stains from a textile than known stain treatment additives. This may improve the ability of the stain treatment additive to remove these stains from the textile and into the wash. The C₁₂ to C₃₀ length of the fatty acid may provide enough hydrophobicity to achieve this effect. A shorter carbon chain length of the fatty acid may not provide enough hydrophobicity. Including more than 30 mols of alkylene oxide may provide too much hydrophilicity.

The textile cleaning composition also comprises at least 10 wt % in total of one or more surfactants or mixtures thereof, not including the stain treatment additive. These further surfactants improve the cleaning effect of the textile cleaning composition and may also keep the stain treatment additive soluble in an aqueous-based formulation or wash liquor over a wide range of conditions. The one or more surfactants may include at least one non-ionic surfactant. The ratio of non-ionic surfactant to stain treatment additive may be at least 0.5:1 by weight, preferably at least 0.8:1 by weight, more preferably at least 1:1 by weight. The non-ionic surfactant may assist in keeping the stain treatment additive stably soluble in an aqueous-based formulation or wash liquor over a wide range of conditions.

The textile cleaning composition may be a stain remover composition. The textile cleaning composition may be a laundry detergent composition. The textile cleaning composition may include any of the features described herein with regard to a stain remover composition or a laundry detergent composition.

The textile cleaning composition comprises at least 0.2 wt % of the stain treatment additive, preferably at least 0.5 wt. %, more preferably at least 1 wt %, more preferably at least 2 wt %, yet more preferably at least 5 wt %. The textile cleaning composition may comprise at most 20 wt % of the stain treatment additive, preferably at most 15 wt %, more preferably at most 10 wt %.

The textile cleaning composition may further comprise one or more builders as discussed herein with reference to a stain remover composition or a laundry detergent composition in an amount as discussed herein with reference to a stain remover composition or a laundry detergent composition. The builder may be included in the textile cleaning composition to enhance the effectiveness of the surfactants used. A builder may also be known as a detergent builder. The builder may comprise one or more species of builder.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure, and are not meant to be limiting in any fashion.

It will be understood that, when describing the number of carbon atoms in a substituent group (e.g. ‘C₁ to C₆’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

It will be understood that any upper or lower quantity or range limit used herein may be independently combined.

Many of the chemicals which may be used to produce the stain treatment additive used in the present invention are obtained from natural sources. Such chemicals typically include a mixture of chemical species due to their natural origin. Due to the presence of such mixtures, various parameters defined herein can be an average value and may be non-integral.

The term ‘glycerol residue’ as used herein, unless otherwise defined, refers to an organic group or moiety derived from a glycerol molecule by removal of one or more active hydrogen atoms, each active hydrogen atom being from one of the hydroxyl groups present on the glycerol molecule.

The stain treatment additive comprises an ester of glycerol and/or polyglycerol. The stain treatment additive may be an ester of glycerol and/or polyglycerol. The ester may comprise glycerol. The ester may comprise a polyglycerol. The polyglycerol may comprise diglycerol, triglycerol, tetraglycerol, pentaglycerol, hexaglycerol and/or mixtures thereof.

The glycerol and/or polyglycerol is alkoxylated. Alkoxylation attaches alkylene oxide residues or groups to the hydroxyl groups of the glycerol.

The glycerol and/or polyglycerol is alkoxylated with up to 30 mols of alkylene oxide, preferably up to 26 mols, more preferably up to 22 mols. The glycerol and/or polyglycerol may be alkoxylated with up to 12 mols of alkylene oxide, preferably up to 10 mols.

The glycerol and/or polyglycerol is alkoxylated with at least 1 mol of alkylene oxide. Preferably the glycerol and/or polyglycerol has been alkoxylated with at least 2 moles of an alkylene oxide, more preferably at least 4 moles, yet more preferably at least 6 moles.

The total number of alkylene oxide residues in the stain remover additive is preferably in the range from 1 to 30, more preferably from 6 to 22, particularly preferably 6 to 12.

The alkylene oxide groups (AO) are typically groups of the formula: —(CᵣH₂ᵣO)— where r is 2, 3 or 4, preferably 2 or 3, i.e. an ethyleneoxy (—C₂H₄O—) or propyleneoxy (—C₃H₆O—) group. AO may represent different groups along an alkylene oxide chain. The alkylene oxide may comprise ethylene oxide, propylene oxide, butylene oxide or mixtures thereof. The alkylene oxide chain may comprise ethylene oxide. The alkylene oxide may consist essentially of or consist of ethylene oxide. Where ethylene oxide and non-ethylene oxide units are used, the molar proportion of ethylene oxide units used may be at least 50 mol %, preferably at least 70 mol %, more preferably at least 80 mol %, most preferably at least 90 mol %. The alkylene oxide may comprise at least 50 mol % ethylene oxide.

The number of alkylene oxide residues in the or each (poly)alkylene oxide chain will preferably be in the range from 1 to 10, more preferably 1 to 8, particularly preferably 1 to 6, most preferably 1 to 4. At least 50 mol % of the alkylene oxide residues may be present in one alkylene oxide chain.

The glycerol and/or polyglycerol may be ethoxylated. The degree of ethoxylation may be equivalent to the degree of alkoxylation discussed above.

The alkoxylated glycerol and/or polyglycerol is esterified to a fatty acid.

The ester may be a mixture of mono-, di- and tri-esters. The ester may comprise higher esters if a polyglycerol with more than 3 free hydroxyl groups is present.

The stain treatment additive may comprise an amount of alkoxylated glycerol and/or polyglycerol that is not esterified. The stain treatment additive may comprise at least 5 wt %, preferably at least 10 wt % un-esterified alkoxylated glycerol or polyglycerol. The stain treatment additive may comprise at most 40 wt %, preferably at most 30 wt % un-esterified alkoxylated glycerol or polyglycerol.

The stain treatment additive may comprise at least 20 wt % of alkoxylated glycerol and/or polyglycerol—fatty acid mono-ester, preferably at least 25 wt %, more preferably at least 30 wt %, even more preferably at least 35 wt %. The stain treatment additive may comprise at most 70 wt % of fatty acid mono-ester, preferably at most 65 wt %, more preferably at most 60 wt %, even more preferably at most 55 wt %.

The stain treatment additive may comprise at least 10 wt % of alkoxylated glycerol and/or polyglycerol—fatty acid di-ester, preferably at least 15 wt %, more preferably at least 20 wt %. The stain treatment additive may comprise at most 50 wt % of fatty acid di-ester, preferably at most 45 wt %, more preferably at most 40 wt %.

The stain treatment additive may comprise at least 1 wt % of alkoxylated glycerol and/or polyglycerol—fatty acid tri-ester, preferably at least 2 wt %, more preferably at least 5 wt %. The stain treatment additive may comprise at most 25 wt % of fatty acid tri-ester, preferably at most 20 wt %, more preferably at most 15 wt %.

The fatty acid in the stain treatment additive comprises at least 12 carbon atoms, preferably at least 14 carbon atoms, more preferably at least 16 carbon atoms.

Including a fatty acid with at least 12 carbon atoms in the stain treatment additive may advantageously increase the hydrophobicity of the stain treatment additive to provide enough solubility in oil and grease so that the stain treatment additive has a greater ability to dissolve stains such as oily or fatty stains from a textile that known stain treatment additives.

The fatty acid in the stain treatment additive comprises at most 30 carbon atoms, preferably at most 26 carbon atoms, more preferably at most 22 carbon atoms, even more preferably at most 20 carbon atoms. The fatty acid may comprise 18 carbon atoms.

Suitable fatty acids can be obtained from natural sources such as, for instance, plant or animal esters (e.g. palm oil, rape seed oil, palm kernel oil, coconut oil, babassu oil, soybean oil, castor oil, tallow, whale or fish oils, grease, lard, and mixtures thereof). The fatty acids can also be synthetically prepared, for example as described in “Fatty Acids in Industry”, Ed. Robert W Johnson, Earl Fritz, Marcel Dekker Inc, 1989 ISBN 0-8247-7672-0.

Accordingly, suitable linear fatty acids include cocoate, capric, lauric, myristic, palmitic, stearic, oleic, linoleic, arachidonic, erucic, behenic acids and mixtures thereof; and suitable branched fatty acids include iso-acids such as isostearic acid, isopalmitic acid, isomyristic acid, isoarachidic, isobehenic acid and mixtures thereof. In one embodiment, the fatty acid is oleic acid, isostearic acid and/or isobehenic acid, more preferably oleic acid and/or isostearic acid, and particularly isostearic acid.

In one preferred embodiment the fatty acid is branched. Preferred branched chain fatty acids are isostearic acid, isomyristic acid, and/or isobehenic acid, more preferably isostearic acid and/or isobehenic acid, and particularly isostearic acid.

The fatty acid component of the ester may comprise a mixture of branched and linear fatty acids. Preferably, the fatty acid mixture comprises at least 50 wt %, more preferably at least 70 wt %, even more preferably at least 80 wt % of branched fatty acids, and less than 30%, more preferably less than 20 wt % by weight of linear fatty acids, both based on the total weight of fatty acids present.

The fatty acid component of the ester preferably comprises alkyl side branches (attached directly to a carbon atom of the longest linear chain) having on average less than 3, more preferably less than 2.5, particularly in the range from 1.05 to 2, and especially 1.1 to 1.4 carbon atoms, i.e. the side branches are predominantly methyl groups. In a preferred embodiment of the invention, at least 50%, more preferably at least 60%, particularly preferably at least 70% by number of the side-branched groups are methyl groups. In a further preferred embodiment, at least 30%, more preferably at least 40%, particularly preferably at least 50% by number of the branched fatty acids contain single methyl side branches.

Suitable branched chain fatty acids for use in the present invention include iso-acids such as isostearic acid, isopalmitic acid, isomyristic acid, isoarachidic acid and isobehenic acid; neo-acids such as neodecanoic acid; and/or anti-iso acids. Preferably, the branched chain fatty acid is an iso-acid. Isostearic acid is preferred. The fatty acid may comprise at least 40 wt % isostearic acid, preferably at least 50 wt % isostearic acid, more preferably at least 60 wt % isostearic acid, even more preferably at least 70 wt % isostearic acid. The fatty acid may consist essentially of or consist of isostearic acid.

The fatty acid may be saturated or unsaturated. Preferably, the fatty acid mixture comprises at least 50 wt %, more preferably at least 70 wt %, even more preferably at least 80 wt % of saturated fatty acids, and less than 30%, more preferably less than 20 wt % by weight of unsaturated fatty acids, both based on the total weight of fatty acids present.

The stain treatment additive is preferably a compound of the formula (I):

Gly.[(AO)ₚ.R]_{q} (I)

where:
Gly is a glycerol and/or polyglycerol residue, preferably a glycerol residue;
AO is an alkylene oxide residue;
each R is independently a C₁₂ to C₃₀ fatty acid residue or H, with at least one C₁₂ to C₃₀ fatty acid residue being present;
each p is independently from 0 to 12; and
q is at least 3 and preferably q is 3
wherein the total number of AO residues in the compound is from 1 to 30.

Since the alkylene oxide residues and fatty acid residues are randomly and statistically distributed on the glycerol residues, for some molecules in the stain treatment additive, all R's may be H (corresponding to a glycerol residue which is not esterified to a fatty acid).

The value of the index p is an average value, which includes statistical variation in the alkylene oxide chain length.

The stain treatment additive may comprise an ester of glycerol and a C₁₆ to C₂₀ fatty acid, wherein the glycerol has been ethoxylated with from 6 to 10 mols of ethylene oxide.

The stain treatment additive may comprise, consist essentially of, or consist of PEG-8 glyceryl isostearate (glycerol ethoxylated with 8 mols of ethylene oxide and esterified with isostearic acid).

Preferably the stain treatment additive comprises at least 50 wt %, more preferably at least 60 wt %, even more preferably at least 70 wt %, yet more preferably at least 80 wt % of PEG-8 glyceryl isostearate.

The hydrophilic-lipophilic balance (HLB value) of a molecule is a measure of the degree to which it is hydrophilic or lipophilic, determined by calculating values for the different regions of the molecule. An HLB value of 0 corresponds to a completely lipophilic/hydrophobic molecule, and a value of 20 corresponds to a completely hydrophilic/lipophobic molecule.

The stain treatment additive may have an HLB value of at least 6, preferably at least 8, more preferably at least 9. The stain treatment additive may have an HLB value of at most 14, preferably at most 12, more preferably at most 11. The stain treatment additive may have an HLB value of about 10.

The HLB value may be measured experimentally by comparison of the solubility behaviour of the stain treatment additive with the solubility behaviour of standard compositions of known HLB or may be calculated theoretically, for example by using Griffin's method.

In isolation, the stain treatment additive may have a low solubility in water. The stain treatment additive alone may not form a stable homogenous solution with water at a concentration of at least 5 wt % in water, preferably not at a concentration of at least 2 wt % in water, more preferably not at a concentration of at least 1 wt % in water, yet more preferably not at a concentration of at least 0.5 wt % in water, with all these measurements taken at 20° C. Without wishing to be bound by theory, this relatively low solubility in water without the presence of other surfactants may make the stain treatment additive more oil and grease soluble and so have a greater ability to dissolve stains such as oily or fatty stains from the textile. This may improve the ability of the stain treatment additive to remove these stains from the textile and into the wash.

To keep the stain treatment additive stable in a aqueous-based formulation or wash liquor a further surfactant or mixture of surfactants may be required. The further surfactants may include at least one non-ionic surfactant and the ratio of non-ionic surfactant to stain treatment additive may be at least 0.5:1 by weight, preferably at least 0.8:1 by weight, more preferably at least 1:1 by weight. The non-ionic surfactant may assist in keeping the stain treatment additive stably soluble in an aqueous-based formulation or wash liquor over a wide range of conditions.

Viewed from a further aspect, the present invention provides a stain remover composition comprising:
at least 0.2 wt % of a stain treatment additive, wherein the stain treatment additive comprises an ester of glycerol and/or polyglycerol and a C12 to C30 fatty acid, wherein the glycerol and/or polyglycerol has been alkoxylated with up to 30 mols of an alkylene oxide; and
at least 10 wt % in total of one or more surfactants or mixtures thereof, not including the stain treatment additive; and
at least 0.5 wt % builder.

The stain remover composition may be applied to a stain on a textile to dissolve the stain from the textile before a rinsing liquid is applied to the textile to remove the stain remover composition and the dissolved stain. The rinsing liquid may comprise water.

The stain treatment additive in the stain remover composition may include any of the features discussed herein with regard to stain treatment additives.

The stain remover composition comprises at least 0.2 wt % of the stain treatment additive, preferably at least 0.5 wt. %, more preferably at least 1 wt %, more preferably at least 2 wt %, yet more preferably at least 5 wt %. The stain remover composition may comprise at most 20 wt % of the stain treatment additive, preferably at most 15 wt %, more preferably at most 10 wt %.

The stain remover composition also comprises at least 10 wt % in total of one or more surfactants or mixtures thereof, not including the stain treatment additive. These further surfactants improve the cleaning effect of the stain remover composition and may also keep the stain treatment additive stably soluble in an aqueous-based formulation over a wide range of conditions. The one or more surfactants may include at least one non-ionic surfactant. The ratio of non-ionic surfactant to stain treatment additive may be at least 0.5:1 by weight, preferably at least 0.8:1 by weight, more preferably at least 1:1 by weight. The non-ionic surfactant may assist in keeping the stain treatment additive stably soluble in an aqueous-based formulation over a wide range of conditions.

The surfactant(s) present in the stain remover composition may serve a range of functions. The stain treatment additive may not be included in the measurement of the amount of surfactant in the stain remover composition. Detergent surfactants can be included to improve the stain removal performance of the composition. Examples include:
anionic detergents such as ether sulphates (alcohol alkoxylate sulphate esters) such as sodium lauryl ether sulphate and ether phosphates e.g. those sold by Croda under the designation Atlas G2203 or Atlas G2207, alkyl and alkaryl sulphonates such as isopropyl amine dodecylbenzene sulfonate; alcohol sulphates, sulphosuccinate mono- and di-esters, ether carboxylates; and
non-ionic detergents such as alkyl phenol ethoxylates, alcohol alkoxylates, particularly ethoxylates, including those sold by Croda under the designation “Synperonic”, particularly grades such as A7, 91/2.5, 91/5 13/10, NCA 850, NCE 7 and LF/RA 30.

The stain remover composition may comprise at least 15 wt % in total of one or more surfactants or mixtures thereof, not including the stain treatment additive, preferably at least 20 wt %. The stain remover composition may comprise at most 50 wt % in total of one or more surfactants or mixtures thereof, not including the stain treatment additive, preferably at most 40 wt %, more preferably at most 30 wt %. The surfactants may assist the stability or solubility of the stain treatment additive in water.

The surfactants may comprise at least 3 wt % of an alcohol alkoxylate, preferably at least 5 wt %, more preferably at least 8 wt %, even more preferably at least 10 wt % of an alcohol alkoxylate, based on the total weight of the stain remover composition. The alcohol alkoxylate may be a C8 to C18 alcohol alkoxylate, preferably a C10 to C16 alcohol alkoxylate. The alcohol alkoxylate may be alkoxylated with up to 20 mols of an alkylene oxide, preferably from 2 to 20 mols of an alkylene oxide, more preferably from 2 to 10 mols of an alkylene oxide. The alkylene oxide may be ethylene oxide. The alcohol alkoxylate may assist the stability or solubility of the stain treatment additive in water.

The builder is included in the stain remover composition to enhance the effectiveness of the surfactants used. A builder may also be known as a detergent builder. The builder may comprise one or more species of builder. Examples of suitable builders include phosphates, orthophosphates, polyphosphates such as tetrapotassium pyrophosphate, silicates and/or metasilicates such as sodium metasilicate, and organic builders such as hydroxycarboxylic acids and their water soluble, particularly alkali metal e.g. Na or K, salts, such as citrates e.g. sodium citrate and gluconates, phosphonic acids and phosphonoalkane carboxylic acids and their water soluble particularly alkali metal e.g. Na or K, salts. The stain remover composition comprises at least 0.5 wt % builder, preferably at least 1 wt % builder, more preferably at least 2 wt % builder, even more preferably at least 5 wt % builder. The stain remover composition may comprise at most 30 wt % builder, more preferably at most 20 wt % builder, even more preferably at most 10 wt % builder.

Typical proportions of builders are from 0.5 to 30%, more usually from 1 to 20%, and desirably from 2 to 10%, by weight of the stain remover composition.

Other ingredients that may be included in the stain remover composition include surfactant detergent materials, dispersants and anti-redeposition agents, fragrances and bleaches, particularly peroxide bleaches. The or each peroxide bleach may be an organic and/or inorganic peroxide or hydrogen peroxide or a source of hydrogen peroxide.

The stain remover composition may comprise at least 1 wt %, preferably at least 2 wt %, more preferably at least 5 wt % of peroxide bleach. The stain remover composition may comprise at most 20 wt %, preferably at most 15 wt %, more preferably at most 10 wt % of peroxide bleach.

The remainder of the stain remover composition may be water. The stain remover composition may comprise at least 30 wt % water, preferably at least 40 wt % water, more preferably at least 50 wt % water.

The stain remover composition may be formulated as a liquid, or as a spreadable gel or solid. Other formulation components, such as solvents e.g. water as can be used with the stain treatment additive as described above, and carriers may be included to achieve a particular desired physical form for the stain remover formulation In particular water can be used as a carrier with benzoate or phenyl alkylcarboxylate esters to formulate them as aqueous emulsions, desirably aqueous micro-emulsions. In this approach, typically, to form a microemulsion a combination of a non-ionic surfactant e.g. an alcohol alkoxylate, and a further surfactant e.g. an alkyl polyglucoside, will be used to microemulsify the stain treatment additive in the water.

The stain treatment additive will often be used in conjunction with water as a solvent or carrier in the stain remover composition. The combination with water e.g. as an aqueous solution, may be a more effective stain remover material than the stain treatment additive itself. When used the proportion of water to stain treatment additive will typically be from 50:1 to 1:10 by weight e.g. by using a 5 to 75%, such as a 5 to 25%, particularly a 7 to 15% by weight aqueous solution of the stain treatment additive. In another embodiment in which the stain remover composition is a gel formulation, it may be desirable to use a concentration of the stain treatment additive in water which is within the gel region that the stain treatment additive may have in aqueous systems.

The amount of the stain remover composition used will generally be enough to treat and usually to wet the textile being treated. The area of the textile treated will generally include all the soiled area which it is desired to treat by, for example pre-spotting the textile with the stain remover composition before washing the textile with a laundry detergent and water or rinsing the textile with water. The soiled area of the textile will usually be treated by spreading e.g. by brushing, spotting or spraying the stain remover composition, depending on the physical form of the formulation, onto and over the soiled area. The soiled area may then be rubbed, brushed or scrubbed to encourage good contact between the stain remover composition and the soil and to aid removal of the soil from the textile.

Viewed from a yet further aspect, the present invention provides a laundry detergent composition comprising:
at least 0.2 wt % of a stain treatment additive, wherein the stain treatment additive comprises an ester of glycerol and/or polyglycerol and a C12 to C30 fatty acid, wherein the glycerol and/or polyglycerol has been alkoxylated with up to 30 mols of an alkylene oxide;
at least 10 wt % in total of one or more surfactants or mixtures thereof, not including the stain treatment additive; and
at least 0.5 wt % builder.

The stain treatment additive in the laundry detergent composition may include any of the features discussed herein with regard to stain treatment additives.

The stain treatment additive may augment the primary washing power of the laundry detergent composition, especially towards oil- and/or fat-containing soils, when washing textiles. The stain treatment additive may produce a significantly better removal of fatty and oily stains on textiles than in the case when using compounds previously known for this purpose. Alternatively, for a constant degree of detergency, significant amounts of surfactants can be economized.

Laundry detergent compositions that comprise the stain treatment additive may comprise all other conventional ingredients of such compositions which do not undergo undesirable interactions with the stain treatment additive. The laundry detergent composition comprises at least 0.2 wt % of the stain treatment additive, preferably at least 0.5 wt. %, more preferably at least 1 wt %, more preferably at least 2 wt %, yet more preferably at least 5 wt %. The laundry detergent composition may comprise at most 20 wt % of the stain treatment additive, preferably at most 15 wt %, more preferably at most 10 wt %.

The presence of the stain treatment additive may provide for more effective stain removal by the laundry treatment composition of the present invention than a comparative laundry detergent composition. Alternatively the laundry treatment composition of the present invention may provide a similar level of stain removal with a lower quantity of conventional surfactant than a comparative laundry detergent composition. It is also possible to provide a laundry detergent composition with a polymer system that provides for both soil suspension and soil removal. The laundry detergent composition may be provided in various forms such as liquids, gels, powders, tablets and, if desired, combinations thereof.

The laundry detergent composition may possess any form, for example it may be a pourable liquid, gel, powder or tablet; preferably it is in the form of a pourable liquid or a gel.

“Pourable liquid” as used herein refers to a liquid having a viscosity such that a consumer may pour it out of a common container for liquid detergents at ambient temperature without effort. To achieve this, viscosities of no more than about 2000 mPa·s at 25° C. at a shear rate of 20 s⁻¹ are normally sufficient.

In some embodiments of the invention, the viscosity of a pourable liquid detergent composition may be in the range of from about 200 to about 1000 mPa·s, preferably from about 200 to about 500 mPa·s, at 25° C. at a shear rate of 20 s⁻¹.

“Gel” as used herein refers to a liquid, preferably a transparent or translucent liquid, having a viscosity of greater than about 2000 mPa·s at 25° C. and at a shear rate of 20 s⁻¹.

The laundry detergent composition comprises at least 10 wt % in total of one or more surfactants or mixtures thereof, not including the stain treatment additive. It is to be understood that these surfactants are distinct from the stain treatment additive. “Surfactant” may refer to one particular surface active agent or to a mixture of two or more surface active agents. The surfactant may assist the stability or solubility of the stain treatment additive in water.

These further surfactants improve the cleaning effect of the laundry detergent composition and may also keep the stain treatment additive stably soluble in an aqueous-based formulation or wash liquor over a wide range of conditions. The one or more surfactants may include at least one non-ionic surfactant. The ratio of non-ionic surfactant to stain treatment additive may be at least 0.5:1 by weight, preferably at least 0.8:1 by weight, more preferably at least 1:1 by weight. The non-ionic surfactant may assist in keeping the stain treatment additive stably soluble in an aqueous-based formulation or wash liquor over a wide range of conditions.

The term detergent is commonly used to refer both to an overall laundry formulation and to individual cleaning surfactant components. Accordingly, for clarity we use the phrase “detergent surfactant” to refer to individual cleaning surfactant components and the phrase “detergent formulation” to refer to combinations of detergent surfactant(s) with other formulation components including the overall laundry detergent composition. The one or more surfactants in the laundry detergent composition may be or comprise one or more detergent surfactants.

The detergent surfactant(s) in the laundry formulation will typically be chosen from non-ionic and anionic detergent surfactants and in particular combinations of non-ionic and anionic detergent surfactants.

Suitable non-ionic detergent surfactants include those based on alkylene oxide derivatives such as polyalkyleneoxy derivatives of alcohols (alkanols), amines, alkanolamides and alkylphenols and amine oxide based detergent surfactants.

Suitable alkanols may contain 6 to 20 carbon atoms, more usually 8 to 18 and particularly 10 to 16 carbon atoms. The alcohol is preferably a primary or secondary alkanol having a linear or mono branched alkyl group.

Suitable alkanolamides are mono- or di-alkanol amides e.g. a mono- or diethanolamide, particularly of a C6 to C30, more usually a C10 to C20, alkanoic acid, e.g. coconut fatty acids, tallow fatty acids or stearic acid.

Suitable alkyl phenols include those having straight chain or branched chain C6 to C20 alkyl groups, particularly those where the alkyl group is para- to the phenolic OH group e.g. para-nonyl phenol and para-dodecyiphenol.

In a preferred embodiment, the laundry detergent composition comprises non-ionic surfactant, selected from fatty alkyl polyglycosides, fatty alkyl polyalkoxylates, especially ethoxylates and/or propoxylates, fatty acid polyhydroxyamides and/or ethoxylated and/or propoxylated products of fatty alkylamines, vicinal diols, fatty acid alkyl esters and/or fatty acid amides as well as their mixtures, especially in an amount in the range 2 wt. % to 25 wt. %.

In general such alkylene oxide derivatives will have 1 to 20, more usually 2 to 10 and particularly 3 to 8, alkylene oxide units per mole of detergent surfactant and are desirably ethylene oxide units although a minor number of propylene oxide or butylene oxide units may also be included. The (poly)-alkyleneoxy chains are generally made by polymerisation and the resulting chain lengths are expressed as average numbers of repeat units and this number may be non-integral.

Another type of alkoxylate non-ionic detergent surfactant are block copolymers of ethylene oxide with propylene oxide and/or butylene oxide. The copolymer typically comprises a block of propylene and/or butylene oxide units on to which is grafted the ethylene oxide. The block of propylene and/or butylene oxide units typically has 20 to 40, particularly about 30, propylene oxide and/or butylene oxide units, such units and 20 to 30, particularly about 26, ethylene oxide units.

Suitable non-ionic amine oxide detergent surfactants have a C10 to C18, particularly a C12 to C16, alkyl group and 2 other groups each individually a C1 to C3 alkyl or hydroxyalkyl group.

Blends or combinations of two or more non-ionic detergent surfactants of similar or different types may be used if desired.

The amount of non-ionic detergent surfactant included in the detergent formulations of and used in the invention is generally from 0.1 to 50%, more usually from 0.2 to 40%, and desirably from 0.5 to 25%, by weight of the overall formulation.

Suitable anionic detergent surfactants may be included if desired. Such anionic surfactants may be of known type for example natural or synthetic soaps, alkylbenzene or olefin sulphonates, alcohol sulphates (also known as primary alkyl sulphates), or alcohol alkoxylate sulphates.

The amount of anionic detergent surfactant included in the detergent formulations of and used in the invention is generally from 0.1 to 50%, more usually from 0.2 to 40%, and desirably from 0.5 to 25%, by weight of the overall formulation. Preferably the one or more surfactants include at least 5 wt % anionic surfactant based on the total weight of the laundry detergent composition.

The laundry detergent composition may include one or more anionic surfactant, preferably of the sulfate and/or sulfonate type, especially fatty alkyl sulfate, fatty alkyl ether sulfate, sulfofatty acid ester and/or di-salts of sulfofatty acid, especially in an amount in the range 2 wt. % to 25 wt. %. The anionic surfactant is preferably selected from the alkyl or alkenyl sulfates and/or the alkyl or alkenyl ether sulfates, in which the alkyl or alkenyl group has 8 to 22, particularly 12 to 18 carbon atoms. These are not usually single substances, but are rather fractions or mixtures. Among these are preferred those whose content of compounds having longer chain groups in the range 16 to 18 carbon atoms is more than 20 wt. %.

As further optional anionic surfactant ingredients one can consider soaps, wherein saturated fatty acid soaps are suitable, such as the salts of lauric acid, myristic acid, palmitic acid or stearic acid, as well as soaps derived from natural fatty acid mixtures such as coconut oil fatty acid, palm kernel oil fatty acid or tallow fatty acid. Those soap mixtures are particularly preferred that are composed of 50 wt. % to 100 wt. % of saturated C12 to C18 fatty acid soaps and up to 50 wt. % of oleic acid soap. Preferably, soap is comprised in amounts of 0.1 wt. % to 5 wt. % of the laundry detergent composition.

Enzymes that are optionally present in the laundry detergent composition are preferably selected from the group that includes protease, amylase, lipase, cellulase, hemicellulases, oxidase, peroxidase or their mixtures. Protease isolated from microorganisms, such as bacteria and fungi, are preferable. They are obtained by means of fermentation processes from suitable microorganisms in a manner known per se. Proteases are commercially available, for example, under the trade names BLAP(R), Savinase(R), Esperase(R), Maxatase(R), Optimase(R), Alcalase(R), Durazym(R) or Maxapem(R). The suitable lipase can be obtained for example from Humicola lanuginosa, from Bacillus types, from Pseudomonas types, from Fusarium types, from Rhizopus types or from Aspergillus types. Suitable lipases are commercially available, for example, under the trade names Lipolase(R), Lipozym(R), Lipomax(R), Amano(R)-Lipase, Toyo-Jozo(R)-Lipase, Meito(R)-Lipase and Diosynth(R)-Lipase. Suitable amylase are commercially available, for example, under the trade names Maxamyl(R), Termamyl(R), Duramyl(R) and Purafect(R) OxAm. Suitable cellulase can be an isolated enzyme from bacteria or fungi and exhibits a pH optimum preferably in the weakly acidic to weakly alkaline region of 6 to 9.5. These types of cellulases are commercially available under the trade names Celluzyme(R), Carezyme(R) and Ecostone(R).

Conventional enzyme stabilizers are also optionally present, particularly in liquid compositions. These enzyme stabilizers include amino alcohols, for example mono-, di-, triethanolamine and mono-, di-, tripropanolamine and their mixtures, lower carboxylic acids, boric acid or alkali metal borates, boric acid carboxylic acid combinations, boric acid esters, boronic acid derivatives, calcium salts, for example the Ca formic acid combination, magnesium salts, and/or sulfur-containing reducing agents.

The total amount of detergent surfactant included in the laundry detergent composition is generally from 10 to 60%, more usually from 15 to 45%, by weight of the overall composition, and may vary depending on the type of formulation (see below for further details).

The laundry detergent composition comprises at least 0.5 wt % builder. A builder may also be known as a detergency builder. The builder may include one or more species of builder. The builder may include a chelating builder or a non-chelating builder. EDTA is an example of a chelating builder, sodium citrate is a builder which is non-chelating.

Builders are included in laundry detergent formulations to improve detergent surfactant cleaning performance, mainly by preferentially reacting with alkaline earth metals, particularly calcium and/or magnesium, typically present as 2+ cations e.g. Mg²⁺ and/or Ca²⁺, in the water to prevent interference with detergent surfactant cleaning performance. Typical builders include inorganic compounds such as alkali metal, usually sodium and/or potassium, more usually sodium, salts such as phosphates, e.g. trisodium phosphate; or condensed phosphates e.g. tetrasodium pyrophosphate, sodium hexametaphosphate and sodium tripolyphosphate; carbonates e.g. sodium carbonate, bicarbonate and/or sesquicarbonate; silicates e.g. sodium meta-silicate; minerals that adsorb or ion exchange the alkaline earth metal ions particularly zeolites [those skilled in the art will appreciate that mineral builders such as zeolites have substantial ion exchange capacity which enable them to absorb alkali metal ions from the aqueous laundry medium and differ from conditioner clays which are layer minerals (with generally limited ion exchange capacity) but which can absorb organic materials such as sebum and carry it onto clothes as described above]; and organic compounds such as nitrilotriacetic acid and its water soluble salts; sodium carboxymethylcellulose; and hydroxycarboxylic acids having 2 to 6 —COOH groups and 1 to 5 —OH groups e.g. citric and/or tartaric acid or their water soluble salts e.g. sodium citrate.

The laundry detergent composition comprises at least 0.5 wt % builder, preferably at least 1 wt % builder, more preferably at least 2 wt % builder, even more preferably at least 5 wt % builder, yet more preferably at least 10 wt % builder. The laundry detergent composition may comprise at most 60 wt % builder, more preferably at most 40 wt % builder, even more preferably at most 20 wt % builder.

The amount of builder included in the detergent formulations of and used in the invention is generally from 2 to 60%, more usually from 2 to 40%, and desirably from 2 to 20%, by weight of the overall formulation.

The laundry detergent composition of and used in the invention may be formulated as liquids, particularly aqueous liquids, which may be packaged conventionally in bottle or similar containers or encapsulated in single dosage forms, particularly in water soluble or water dispersible film packaging usually provided to the end user in unit dose form (commonly called “liquitabs”); or as solids, typically either as powders or as tablets, usually each containing an amount of the detergent formulation suitable for a single wash.

Liquid laundry detergent formulations of and used in the invention will typically have formulations including the following components:

a. detergent surfactants—usually a combination of non-ionic e.g. alcohol alkoxylates, and anionic surfactants e.g. alkali metal linear alkyl benzene sulphonates and/or alcohol sulphates, optionally, but commonly, including a minor proportion of fatty acid soap(s)—typically the overall level of detergent surfactants is in the range 15 to 50%, more usually 20 to 50%, desirably 20 to 40%, by weight of the composition; in this commonly from generally 0.5 to 35%, more usually 0.5 to 30% and desirably 0.5 to 25%, by weight is non-ionic surfactant; and generally 0.5 to 35%, more usually 0.5 to 30% and desirably 0.5 to 25%, by weight is anionic surfactant, which may include fatty acid soaps;

b. builder—which can be phosphate, including phosphonate, zeolite, hydroxy acid, or alkali metal hydroxide, carbonate or silicate or a combination of two or more of these types e.g. zeolite and alkali metal, particularly sodium, carbonate, but it is not unusual and may be desirable to use wholly water soluble builders; with a typical overall builder level in the range 0.5 to 10%, more usually 1 to 8%, and desirably 2 to 6%, by weight of the composition;

Minor components could typically include fluoresce(s) (optical brighteners), antifoam(s), bleach(es), bleach activator(s) enzyme(s), fragrance(s), anti-redeposition agent(s) (CMC), opacifier(s), preservative(s) and thickener(s). These are used at conventional levels (which will depend on the particular component) but are each usually not more than 5% by weight.

Packaged or encapsulated liquids (“liquitab” type), will typically have similar formulations to liquid type detergent formulations. Liquitab formulations may have less water content than liquid detergent formulations since they may be encapsulated in water soluble or water dispersible films. Liquitab or encapsulated liquid laundry detergent compositions may comprise at most 10 wt % water.

Preferably the laundry detergent composition comprises at least 15 wt % in total of the one or more surfactants or mixtures thereof, and the laundry detergent composition is a liquid laundry detergent composition. Preferably the laundry detergent composition is a liquid laundry detergent composition which is encapsulated in a unit dosage form and which comprises at most 10 wt % water.

The ranges (in % by weight) in the following table are representative of typical such aqueous liquid, including packaged liquid, formulations (other than minor components):

Liquid Detergent Formulation

| | general | typical | desirable |
|---|---|---|---|
| Detergent | 15 to 50 | 20 to 50 | 20 to 40 |
| Anionic | 0.5 to 35 | 0.5 to 30 | 0.5 to 25 |
| Non-ionic | 0.5 to 35 | 0.5 to 30 | 0.5 to 25 |
| Builder | 0.5 to 10 | 1 to 8 | 2 to 6 |
| Solvents/dispersants | 0.5 to 10 | | |
| (when present) | | | |
| Fabric Conditioner | 0.2 to 10 | 0.5 to 7 | 0.75 to 4 |

| | |
|---|---|
| Water | to 100% |

Solid laundry detergent formulations of and used in the invention will typically have compositions including the following components (apart from the non-ionic conditioner):

a. detergent surfactants—usually a combination of non-ionic e.g. alcohol alkoxylates, and anionic surfactants e.g. alkali metal linear alkyl benzene sulphonates and/or alcohol sulphates, optionally, but commonly, including a minor proportion of fatty acid soap(s)—typically the overall level of detergent surfactants is in the range 10 to 60%, more usually 12 to 40% and desirably 15 to 30%, by weight of the composition; amounts in the range 10 to 60%, more usually 12 to 25% and desirably 15 to 20%, by weight being typical for standard powders and generally 15 to 60%, more usually 20 to 40% and desirably 20 to 30%, by weight being typical for concentrated powders; and within these totals, commonly from 0.1 to 50%, more usually 0.5 to 25% and desirably 0.5 to 20%, by weight for standard powders and 0.5 to 50%, more usually 0.5 to 35% and desirably 0.5 to 20%, by weight for concentrated powders is non-ionic surfactant(s), which may include fatty acid soaps;

b. builder—which can be phosphate, zeolite, hydroxy acid, or alkali metal hydroxide, carbonate, citrate or silicate, or commonly and frequently desirably, a combination of two or more of these types e.g. zeolite and alkali metal carbonate, particularly sodium carbonate; —typically the overall level of builder(s) is in the range 20 to 80%, more usually 30 to 60%, and desirably 35 to 55%, by weight of the composition, —with ranges for the specific types of builder in a combination formulation of: zeolite—typically 10 to 50%, more usually 15 to 40%, and desirably 20 to 35% and alkali metal salt builder typically 10 to 40%, more usually 12 to 35%, and desirably 10 to 20%, adjusted for whether the overall formulation is a standard or concentrated powder;

Minor components could typically include fluoresce(s) (optical brighteners), antifoam(s), bleach(es), bleach activator(s) enzyme(s), fragrance(s), anti-redeposition agent(s) (CMC). These are used at conventional levels (which will depend on the particular component) but are usually not more than 5% by weight each.

The ranges (in % by weight) in the following table are representative of typical such powder formulations (other than minor components):

Standard powder formulations

| | typical | desirable | preferred |
|---|---|---|---|
| Detergent | 10 to 60 | 12 to 25 | 15 to 20 |
| Anionic | 0.1 to 50 | 0.5 to 25 | 0.5 to 20 |
| Non-ionic | 0.1 to 50 | 0.5 to 25 | 0.5 to 20 |
| Builder | 20 to 80 | 30 to 60 | 35 to 45 |
| of which: | | | |
| mineral (especially) zeolite type | 10 to 40 | 15 to 30 | 20 to 25 |
| alkali metal salt type | 10 to 40 | 12 to 35 | 15 to 20 |
| Fabric Conditioner | 0.2 to 10 | 0.5 to 7 | 0.75 to 4 |

Concentrated powder formulations

| | typical | desirable | preferred |
|---|---|---|---|
| Detergent | 15 to 60 | 20 to 40 | 20 to 30 |
| Anionic | 0.1 to 50 | 0.5 to 35 | 0.5 to 20 |
| Non-ionic | 0.1 to 50 | 0.5 to 35 | 0.5 to 20 |
| Builder | 30 to 75 | 30 to 60 | 40 to 55 |
| of which: | | | |
| mineral (especially) type | 20 to 50 | 25 to 40 | 30 to 35 |
| alkali metal salt type | 10 to 25 | 12 to 20 | 10 to 15 |
| Fabric Conditioner | 0.2 to 10 | 0.5 to 7 | 0.75 to 4 |

Solid tablets will typically have similar formulations to concentrated powder type detergent formulations (but may further include binder) and the ranges (in % by weight) in the following table are representative of typical such tablet formulations (other than minor components):

Solid tablet formulations

| | typical | desirable | preferred |
|---|---|---|---|
| Detergent | 15 to 60 | 20 to 40 | 20 to 30 |
| Anionic | 0.1 to 50 | 0.5 to 35 | 0.5 to 20 |
| Non-ionic | 0.1 to 50 | 0.5 to 35 | 0.5 to 20 |
| Builder | 30 to 75 | 30 to 60 | 40 to 55 |
| of which: | | | |
| mineral (especially) type | 20 to 50 | 25 to 40 | 30 to 35 |
| alkali metal salt type | 10 to 25 | 12 to 20 | 10 to 15 |
| Fabric Conditioner | 0.2 to 10 | 0.5 to 7 | 0.75 to 4 |
| Binder (when present) | 1 to 10 | 2 to 7 | 3 to 5 |

The detergent formulations of and used in the invention may also contain additives conventionally found in such formulations e.g. optical brighteners, antifoam, chelating agents such as ethylene diamine tetra acetic acid, dyes, fragrances or perfumes, enzymes, bleaches, bleach activators, opacifiers, inert fillers e.g. sodium or potassium sulphate, antiredeposition agents such as carboxymethylcellulose (CMC), preservatives and, for liquid formulations, particularly aqueous formulations, thickeners. These are used at conventional levels (which will depend on the particular component) but are usually not more than 5% by weight each.

Laundry cleaning operations of the invention will usually be carried out with the aqueous laundry medium at a temperature of from ambient cold water temperature (typically about 10° C.) to boiling (about 100° C.), more particularly at 25 to 60° C. Further the pH of the wash medium will typically be at least 7 and desirably from 8 to 10. Correspondingly the detergent formulations of the invention desirably yield such pH values when dispersed in the laundry aqueous cleaning medium to form a wash liquor.

Viewed from a further aspect, the present invention provides a method of cleaning a textile which comprises:
applying an amount of a stain treatment additive to the textile, wherein the stain treatment additive comprises an ester of glycerol and/or polyglycerol and a C12 to C30 fatty acid, wherein the glycerol and/or polyglycerol has been alkoxylated with up to 30 mols of an alkylene oxide; and
applying a rinsing liquid to the textile.

The method of the invention may include any of the features discussed herein with regard to the stain treatment additive, the textile cleaning composition, the stain remover composition or the laundry detergent composition.

Preferably, the stain treatment additive is included in a textile cleaning composition as discussed herein, a laundry detergent composition as discussed herein or a stain remover composition as discussed herein.

The textiles to be cleaned will usually be garments and can be of woven or non-woven fabrics. The fibre making up the fabric can be or include a wide range of natural and synthetic fibres including polyamides particularly natural polyamides such as silk and wool and synthetic polyamides such as nylon, cellulosic fibres such as cotton, linen and rayon, synthetic polymers such as polyester, particularly polyethylene terephthalate or related copolymers, or acetate polymers.

The rinsing liquid may comprise water. The rinsing liquid may be provided in a wash cycle and/or a rinse cycle.

The method may comprise a wash cycle in which the textile is contacted with water and the stain treatment additive. The water and the stain treatment additive may be components of a wash liquor which is formed during the wash cycle. The textile may also be contacted with at least one detergent surfactant. The at least one detergent surfactant may be provided by a laundry detergent composition. Preferably the stain treatment additive and the at least one detergent surfactant are provided in a laundry detergent composition as discussed herein. The wash liquor may comprise the laundry detergent composition and water. The wash cycle may maintain the contact between the textile and the stain treatment additive so that the textile is treated with the stain treatment additive.

Preferably the method of the invention further comprises a rinse cycle. The rinse cycle may maintain the contact between the rinsing liquid and the textile so that the stain treatment additive is removed, preferably substantially removed, from the textile. A fabric conditioners may be included in the rinse cycle which may include a fatty branched polyalkyloxylate.

Any suitable apparatus for laundry may be used in the method. Typically such apparatus includes a drum in which the wash cycle and/or rinse cycle is carried out. The drum may have its axis horizontal or vertical. (Other angles of orientation will generally be less convenient in operation.) Providing agitation in a horizontal axis drum can simply be by rotation around its axis. Vertical axis drums will usually include an agitator which can be moved to agitate the drum contents. Other means of agitation include paddles or vanes in the drum. Suitably vigorous agitation may improve the cleaning performance.

Specific steps of the method may depend on the equipment used. The textile or textiles may be introduced into the drum which is then sealed and filled with a wash liquor. The textiles and wash liquor are then agitated to give thorough mixing and contact between the wash liquor and textiles. The textiles will be contacted with the wash liquor for a time adequate to clean the textiles to the desired extent. The wash liquor is then separated from the textiles, typically by draining it from the drum. Generally the textiles will be subject to one such wash cycle, but if desired the wash cycle may be repeated to obtain a higher degree of cleaning. Usually, the textiles are subject to at least one rinse cycle usually not including cleaning additives, but which may include fabric softeners, optical bleaches etc if desired. The rinse liquid is similarly separated from the textiles, which can then recovered by opening the drum to remove the textiles.

The method may include a pre-wash treatment in which the stain treatment additive may be contacted with a stained area of the textile. In a pre-wash treatment, the stain treatment additive is preferably included in a stain remover composition as described herein.

Viewed from a still further aspect, the present invention provide the use of an ester of glycerol and/or polyglycerol and a C12 to C30 fatty acid, wherein the glycerol and/or polyglycerol has been alkoxylated with up to 30 mols of an alkylene oxide to treat a stain on the textile.

In the use, the ester may be included in a stain remover composition or a laundry detergent composition.

The use of the invention may include any of the features discussed herein with regard to the stain treatment additive, the textile cleaning composition, the stain remover composition or the laundry detergent composition.

The stain removing efficacy of the stain treatment additive described herein may be quantified by the measurement of Y values of stains before and after washing. Y value measurements may be obtained using a spectrophotometer.

The difference in the whiteness/brightness (measured as Y-colour or Y-value, with a higher Y value indicating a whiter colour) within I*a*b colour space of the washed stain compared with the unwashed stain may be given as a Delta Y (or ΔY) value where Delta Y=Y_{washed}−Y_{unwashed}. A higher Delta Y value signifies that more of the stain has been removed from the textile.

A stain on a textile which has been treated by a stain treatment additive (or ester) as described herein may have a delta Y value at least 4% higher than a stain treated with a stain remover composition or a laundry detergent composition of an equivalent formulation in which the stain treatment additive (or ester) has been replaced with water. The delta Y value is preferably at least 8% higher, more preferably at least 10% higher, even more preferably at least 15% higher.

The delta Y value may be measured with regard to a single stain or may be an average over a plurality of stains. The delta Y value may be measured with regard to one or more of the following standard stains obtained from the Center For Test materials BV (reference codes included in brackets):
A—Coffee (C-BC-02)—a bleachable stain;
B—Dressing (CS-6)—an enzyme treatable stain;
C—Oatmeal/Chocolate (CS-54)—an enzyme treatable stain;
D—Grass (CS-08)—an enzyme treatable stain;
E—Olive Oil/Soot (C-02)—an oily/particulate stain;
F—Rice Starch (CS-28), —an enzyme treatable stain;
G—Corn Starch (CS-26)—an enzyme treatable stain;
H—Locustbean gum (CS-73)—an enzyme treatable stain, and
I—Pigment/Oil/Milk (C-10)—an oily/particulate stain.

The delta Y value may be over an average of stains A to E. The delta Y value may be over an average of stains A to I.

A stain on the textile which has been treated by the stain treatment additive (or ester) may have a delta Y value at least 10% higher than a stain treated with a stain remover composition or a laundry detergent composition of an equivalent formulation but which does not include the stain treatment additive or ester.

The stain may be selected from the group consisting of: coffee, dressing, oatmeal, chocolate, grass, olive oil, soot, rice starch, corn starch, locustbean gum, pigment, oil, milk and mixtures thereof.

The stain may be selected from the group consisting of: coffee, dressing, oatmeal, chocolate, grass, olive oil, soot and mixtures thereof.

The stain may be selected from the group consisting of: a bleachable stain, an enzyme treatable stain, and an oily/particulate stain. Preferably the stain is an oily/particulate stain.

All of the features described herein may be combined with any of the above aspects of the invention, in any combination.

### EXAMPLES

The present invention will now be described further by way of example only with reference to the following Examples. All parts and percentages are given by weight unless otherwise stated.

It will be understood that all tests and physical properties listed have been determined at atmospheric pressure and room temperature (i.e. about 20° C.), unless otherwise stated herein, or unless otherwise stated in the referenced test methods and procedures.

The following test methods and procedures will be used for measurement of chemical characteristics unless otherwise stated:

Acid Number

The acid number/value was determined by using ASTM D1980-87 (Standard test method for acid value of fatty acids and polymerised fatty acids).

Hydroxyl Number

The hydroxyl number/value was measured by using ASTM D1957-86 (Standard test method for hydroxyl value of fatty oils and acids).

Saponification Number

The saponification number/value was measured by using ASTM D5558 (Standard test method for vegetable and animal fats).

In these examples, the Stain Treatment Additives (STA) listed in table 1 below will be used.

TABLE 1
Stain Treatment Additives used in the Examples

| Short Name | Chemical Composition |
|---|---|
| STA1 | PEG-8 Glyceryl Isostearate |
| STA2 | PEG-20 Glyceryl Tri-isostearate |

### Example 1

### Preparation of Stain Treatment Additive 1 (STA1)

A batch of PEG-8 Glyceryl Isostearate (STA1) was prepared as follows. Table 2 shows the charge weights for an approximately 4 kg batch.

TABLE 2
Charge weights for preparation of STA1

| Material | Amount/g |
|---|---|
| Glycerine ethoxylated with 8 mols of Ethylene Oxide | 2550.7 |
| Isostearic acid | 1545.8 |
| Acid Catalyst 50% aq | 12.3 |
| Inorganic Base 50% aq | 8.2 |

The ethoxylated glycerine, isostearic acid and acid catalyst (for example, p-toluenesulfonic acid (PTSA), methanesulfonic acid (MSA) or hypophosphorous acid) were charged to a flask and heated to 220° C. with nitrogen sparge and a condenser set to reflux. After 1 hour the condenser was set for distillation and reaction was continued at 220° C. for a further 5 hours. After cooling to 90° C. the inorganic base (for example NaOH, KOH or K₂CO₃) was added and stirring was continued at this temperature for 30 minutes. Vacuum (<40 mbar) was applied for 30 minutes and then released using nitrogen. The crude product was filtered through filter aid to yield STA1 as a clear yellow oil.

STA1 is a clear liquid at room temperature. It meets the specification shown in table 3.

TABLE 3
specification of STA1

| Parameter | Specification | Units |
|---|---|---|
| Acid number | 0 to 5.0 | mgKOHg⁻¹ |
| Saponification number | 67 to 83 | mgKOHg⁻¹ |
| Hydroxyl number | 142 to 162 | mgKOHg⁻¹ |
| pH (1%) | 4.0 to 7.0 | — |

### Example 2

### Preparation of an Example Stain Remover Composition Including STA1

A stain remover composition was prepared using STA1 with the ingredients listed in table 4. The formulation is suitable for a trigger pack application.

TABLE 4
Stain remover composition

| | | Wt % of |
|---|---|---|
| Component | Function | Composition |
| Water | Solvent | 66.47 |
| Synperonic A7 ex Croda | Surfactant | 5.00 |
| Synperonic 13/8 ex Croda | Surfactant | 5.00 |
| ethylenediamine-N,N′-disuccinic | Builder/Chelant | 2.00 |
| acid (EDDS) (35%) | | |
| Benzisothiazolinone | Preservative | 0.03 |
| STA1 | Stain Treatment | 10.00 |
| | Additive | |
| C8/10 alkyl polyglucoside | Surfactant | 10.00 |
| Ethanol | Solvent | 1.50 |

### Example 3

### Preparation of an Example Liquid Laundry Detergent Composition Including STA1

A liquid laundry detergent containing STA1 was formulated. The ingredients are shown in Table 5.

TABLE 5
Liquid Laundry Detergent Composition

| | | Wt % of |
|---|---|---|
| Component | Function | Composition |
| Water | Solvent | 39.45 |
| Ethanol | Solvent | 4.00 |
| Linear Alkyl Benzene Sulphonate | Surfactant | 5.00 |
| (LAS) | | |
| Sodium Lauryl Ether Sulphate | Surfactant | 23.50 |
| (SLES 30%) | | |
| Non-ionic surfactant blend | Surfactant | 15.00 |
| STA1 | Stain Treatment | 5.00 |
| | Additive | |
| Oleic/coconut fatty acid based | Soap | 5.00 |
| sodium soap | | |
| Sodium Citrate | Builder | 3.00 |
| Benzisothiazolinone | Preservative | 0.05 |

### Example 4

### Laundry Detergent 1 to 3 Washing Results

In this Example, the following conditions and procedures were used.

a) Washing Conditions

The following standard washing conditions were used.
Washing machine: Miele® W 526 Novotronic (with automatic load control deactivated)
Wash program: 40° C. cotton cycle main wash programme
Wash temperature: 40° C.
Dosage of detergent: 80 ml
Amount of laundry: 3.5 kg clean textiles according to IEC 60456 (2 cotton bed sheets IEC T11, 3 cotton pillowcases IEC T13, 8 cotton huckabuck towels IEC T12) incl. test fabrics

b) Stained Textiles

The following standardised stains were purchased from Center For Testmaterials BV (reference codes included in brackets).
A—Coffee (C-BC-02)—a bleachable stain;
B—Dressing (CS-6)—an enzyme treatable stain;
C—Oatmeal/Chocolate (CS-54)—an enzyme treatable stain;
D—Grass (CS-08)—an enzyme treatable stain;
E—Olive Oil/Soot (C-02)—an oily/particulate stain;
F—Rice Starch (CS-28), —an enzyme treatable stain;
G—Corn Starch (CS-26)—an enzyme treatable stain;
H—Locustbean gum (CS-73)—an enzyme treatable stain, and
I—Pigment/Oil/Milk (C-10), —an oily/particulate stain.

The stained textiles A to I were washed under the above washing conditions with a laundry detergent that comprised (all percentages by weight):

Laundry Detergent 1:
15.0% C8 fatty alcohol ethoxylate,
7.0% sodium lauryl ether sulphate,
5.0% of STA1 prepared according to Example 1 above,
5.0% sodium lauryl sulphate,
5.0% fatty acid soap (oleic/coconut-based sodium soap),
4.0% ethanol,
3.0% sodium citrate,
0.05% benzisothiazalinone; and
water up to 100%,
pH 8.5.

After washing the textiles were tumble dried (Indesit™ IS60V tumble drier, High heat 60 minutes drying programme) and then left to further air dry in a temperature (20-22° C.) and humidity (45-55%) controlled environment. Once dried all swatches were measured on an X-Rite Color i5 spectrophotometer in reflectance mode with a 25 mm aperture to determine the brightness (Y-colour or Y-value) within I*a*b colour space of the washed stain and the unwashed stain.

The evaluation of detergency by this colorimetric analysis compared the result of the STA1 containing detergent with the result of a detergent described as above, but in which the STA1 was replaced by water (Laundry Detergent 2). The results in Table 6 below are the differences in the whiteness/brightness (measured as Y-colour or Y-value, with a higher Y value indicating a whiter colour) within I*a*b colour space of the washed stain compared with the unwashed stain. The difference in whiteness is given as Delta Y value where Delta Y=Y_{washed}−Y_{unwashed}.

TABLE 6
delta Y values for stains A to E-Laundry Detergents 1 and 2

| | | | | | | Average |
|---|---|---|---|---|---|---|
| Delta Y values for stains A to E | A | B | C | D | E | of A to E |
| Laundry Detergent 1 | 5.60 | 7.23 | 9.25 | 5.65 | 11.21 | 7.79 |
| (including 5 wt % STA1) | | | | | | |
| Laundry Detergent 2 | 4.69 | 6.94 | 8.11 | 4.70 | 9.92 | 6.87 |
| (5 wt % STA1 replaced with water) | | | | | | |
| Improvement in delta Y value for | 19.4% | 4.2% | 14.1% | 20.2% | 13.0% | 13.4% |
| Laundry Detergent 1 compared with | | | | | | |
| Laundry Detergent 2 | | | | | | |

Laundry Detergent 1 with the inclusion of STA1 showed a significantly improved stain removing power against all stains A to E than the otherwise identical composition without STA1 (Laundry Detergent 2).

As can be seen in the last row of Table 6, the inclusion of STA1 at 5 wt % provided an improvement of between 4.2% and 20.2% in the stain removal power of Laundry Detergent 1 with regard to stains A to E. The average improvement in stain removal across all 5 stains was 13.4%.

TABLE 7
delta Y values for stains E to I-Laundry Detergents 1, 2 and 3

| Delta Y values for stains E to I | E | F | G | H | I | Average of E to I |
|---|---|---|---|---|---|---|
| Laundry Detergent 1 | 11.21 | 9.79 | 8.27 | 10.69 | 7.04 | 9.40 |
| (including 5 wt % STA1) | | | | | | |
| Laundry Detergent 2 | 9.92 | 9.12 | 7.94 | 7.76 | 5.52 | 8.05 |
| (5 wt % STA1 replaced with water) | | | | | | |
| Laundry Detergent 3 | 11.27 | 9.66 | 8.29 | 8.34 | 6.76 | 8.86 |
| (including 5 wt % STA2) | | | | | | |
| Improvement in delta Y value for | 13.6% | 5.9% | 4.4% | 7.5% | 22.5% | 10.8% |
| Laundry Detergent 3 compared with | | | | | | |
| Laundry Detergent 2 | | | | | | |

In Laundry Detergent 3 the 5 wt % STA1 in Laundry Detergent 1 was replaced with 5 wt % STA2. It can be seen from Table 7 that STA2 performs on average better than water (as shown by Laundry Detergent 2) for stain removal of stains E to I but not as well as STA1.

### Example 5

### Laundry Detergents 4 to 7 Washing Results

Another set of the stained textiles A to E and the washing conditions of Example 4 were used in Example 5.

The stained textiles A to E were washed under the above conditions with a laundry detergent that comprised (all percentages by weight):

Laundry Detergent 4
9.9% fatty acid soap (oleic/coconut-based sodium soap),
6.0% C12-15 fatty alcohol ethoxylated with 7 mols of Ethylene Oxide,
5.6% C8-10 alkyl polyglucoside,
4.3% sodium lauryl ether sulphate (SLES),
5.0% of STA1 prepared according to Example 1 above,
5.0% sodium lauryl sulphate (SLS),
3.0% ethanol,
4.0% sodium citrate,
0.05% benzisothiazalinone; and
water up to 100%,
pH 8.0

After washing the textiles were tumble dried (Indesit™ IS60V tumble drier, High heat 60 minutes drying programme) and then left to further air dry in a temperature (20-22° C.) and humidity (45-55%) controlled environment. Once dried all swatches were measured on an X-Rite Color i5 spectrophotometer in reflectance mode with a 25 mm aperture as described in Example 4.

The evaluation of detergency was by the colorimetric analysis described above by comparing the result of Laundry Detergent 4 with the result of a detergent in which the 5.0 wt % of STA1 in Laundry Detergent 4 was replaced by:
i. 3.0% STA1 and 2.0% water (Laundry Detergent 5),
ii. 5.0% glycerine (Laundry Detergent 6), and
iii. 5.0% water (Laundry Detergent 7).

The results in Table 7 below are the differences in the brightness (Y-colour or Y-value) within I*a*b colour space (delta Y) of the washed stain with the unwashed stain.

TABLE 8
delta Y values for stains A to E-Laundry Detergents 4 to 7

| | | | | | | Average of |
|---|---|---|---|---|---|---|
| Delta Y values | A | B | C | D | E | A to E |
| Laundry Detergent 4- | 2.75 | 5.23 | 11.46 | 9.71 | 11.35 | 8.1 |
| formulation with 5% STA1 | | | | | | |
| Laundry Detergent 5- | 2.70 | 4.30 | 10.99 | 8.86 | 10.26 | 7.4 |
| formulation with 3% STA1 | | | | | | |
| Laundry Detergent 6- | 1.69 | 5.24 | 9.58 | 8.17 | 9.95 | 6.9 |
| formulation with 5% glycerine | | | | | | |
| Laundry Detergent 7- | 2.07 | 3.63 | 10.17 | 8.48 | 9.00 | 6.67 |
| formulation with 5% water | | | | | | |

As can be seen from Table 8, inclusion of 5 wt % STA1 or 3 wt % STA1 provides Laundry Detergents 4 and 5 with a better stain treatment performance on average and for most individual stains when compared with the inclusion of glycerine in Laundry Detergent 6 or water in Laundry Detergent 7.

### Example 6

### Stain Remover Composition Results

Another set of the stained textiles A to E of Example 4 were used in Example 6.

The stained textiles were treated with 1.3 g of a stain remover formulation that comprises (all percentages by weight):

Stain Remover 1
10.0% STA 1 of Example 1
7.0% C8-10 alkyl polyglucoside,
5.0% C12-15 fatty alcohol with 7 EO,
5.0% C13 fatty alcohol with 8 EO,
2.0% ethylenediamine-N,N′-disuccinic acid,
1.5% ethanol,
0.05% benzisothiazalinone; and
water up to 100%,
pH 7.0

Stain Remover 1 was applied to each stained square without rubbing with a contact time of less than 5 minutes.

Next, the washing procedure defined in Example 4 was used except a powder detergent (80 g dose, ECE-2 reference detergent) was used in all tests. After washing the textiles were tumble dried (Indesit™ IS60V tumble drier, High heat 60 minutes drying programme) and then left to further air dry in a temperature (20-22° C.) and humidity (45-55%) controlled environment. Once dried all swatches were measured on an X-Rite Color i5 spectrophotometer in reflectance mode with a 25 mm aperture as described in Example 4 above.

The evaluation of stain removal was by the colorimetric analysis comparing the result of Stain Remover 1 with a stain remover with a formulation similar to Stain Remover 1 in which the STA1 was replaced by Dowanol DPM, a comparative stain treatment additive, which comprises di-propylene glycol methyl ether (Stain Remover 2). The results below are the differences in the brightness, Y-colour, within I*a*b colour space (delta Y) of the washed stain with the unwashed stain.

TABLE 9
delta Y values for stains A to E-Stain Removers 1 and 2

| | | | | | | Average of |
|---|---|---|---|---|---|---|
| Delta Y Values | A | B | C | D | E | A to E |
| Stain Remover 1- | 3.85 | 15.25 | 12.53 | 9.94 | 22.44 | 12.8 |
| with STA1 (10 wt %) | | | | | | |
| Stain Remover 2- | 3.23 | 13.06 | 9.09 | 9.01 | 19.42 | 10.8 |
| with Dowanol DPM (10 wt %) | | | | | | |
| Improvement in Delta Y value for | 19.2% | 16.8% | 37.8% | 10.3% | 15.6% | 18.5% |
| Stain Remover 1 compared with | | | | | | |
| Stain Remover 2 | | | | | | |

Stain Remover 1 with the inclusion of STA1 showed a significantly improved stain treatment power than the otherwise identical composition containing Dowanol DPM.

It is to be understood that the invention is not to be limited to the details of the above embodiments, which are described by way of example only. Many variations are possible.

1. A textile cleaning composition comprising:
at least 0.2 wt % of a stain treatment additive, wherein the stain treatment additive comprises an ester of glycerol and/or polyglycerol and a C₁₂ to C₃₀ fatty acid, wherein the glycerol and/or polyglycerol has been alkoxylated with up to 30 mols of an alkylene oxide; and
at least 10 wt % in total of one or more surfactants or mixtures thereof, not including the stain treatment additive.

2. A textile cleaning composition as claimed in claim 1 wherein the one or more surfactants include at least one non-ionic surfactant and the ratio of non-ionic surfactant to stain treatment additive is at least 0.5:1 by weight.

3. A textile cleaning composition as claimed in claim 1 wherein the alkylene oxide comprises at least 50 mol % ethylene oxide.

4. A textile cleaning composition as claimed in claim 1 wherein the fatty acid comprises at least 50 wt % isostearic acid, based on the total weight of fatty acid present.

5. A textile cleaning composition as claimed in claim 1 wherein the ester comprises at least 20 wt % mono-ester.

6. A textile cleaning composition as claimed in claim 1 wherein the stain treatment additive comprises an ester of glycerol and a C₁₆ to C₂₀ fatty acid, wherein the glycerol has been ethoxylated with from 6 to 10 mols of ethylene oxide.

7. A laundry detergent composition comprising:
at least 0.2 wt % of a stain treatment additive, wherein the stain treatment additive comprises an ester of glycerol and/or polyglycerol and a C₁₂ to C₃₀ fatty acid, wherein the glycerol and/or polyglycerol has been alkoxylated with up to 30 mols of an alkylene oxide;
at least 10 wt % in total of one or more surfactants or mixtures thereof, not including the stain treatment additive; and
at least 0.5 wt % builder.

8. A laundry detergent composition as claimed in claim 7 wherein the one or more surfactants include at least one non-ionic surfactant and the ratio of non-ionic surfactant to stain treatment additive is at least 0.5:1 by weight.

9. A laundry detergent composition as claimed in claim 7 wherein the alkylene oxide comprises at least 50 wt % ethylene oxide.

10. A laundry detergent composition as claimed in claim 7 wherein the fatty acid comprises at least 50 wt % isostearic acid, based on the total weight of fatty acid present.

11. A laundry detergent composition as claimed in claim 7 wherein the ester comprises at least 20 wt % mono-ester.

12. A laundry detergent composition as claimed in claim 7 wherein the stain treatment additive comprises an ester of glycerol and a C₁₆ to C₂₀ fatty acid, wherein the glycerol has been ethoxylated with from 6 to 10 mols of ethylene oxide.

13. A laundry detergent composition as claimed in claim 7 wherein the one or more surfactants include at least 5 wt % anionic surfactant based on the total weight of the laundry detergent composition.

14. A laundry detergent composition as claimed in claim 7 which comprises at least 15 wt % in total of the one or more surfactants or mixtures thereof, and in which the laundry detergent composition is a liquid laundry detergent composition.

15. A laundry detergent composition as claimed in claim 14 wherein the laundry detergent composition is a liquid laundry detergent composition which is encapsulated in a unit dosage form and which comprises at most 10 wt % water.

16. A stain remover composition comprising:
at least 0.2 wt % of a stain treatment additive, wherein the stain treatment additive comprises an ester of glycerol and/or polyglycerol and a C₁₂ to C₃₀ fatty acid, wherein the glycerol and/or polyglycerol has been alkoxylated with up to 30 mols of an alkylene oxide; and
at least 10 wt % in total of one or more surfactants or mixtures thereof, not including the stain treatment additive; and
at least 0.5 wt % builder.

17. A stain remover composition as claimed in claim 16 wherein the alkylene oxide comprises at least 50 mol % ethylene oxide.

18. A stain remover composition as claimed in claim 16 wherein the one or more surfactants comprise at least 5 wt % of an alcohol alkoxylate, based on the total weight of the textile cleaning composition.

19. A stain remover composition as claimed in claim 16 wherein the stain remover composition further comprises at least 2 wt % of a peroxide bleach.

20. A method of cleaning a textile which comprises:
applying an amount of a stain treatment additive to the textile, wherein the stain treatment additive comprises an ester of glycerol and/or polyglycerol and a C₁₂ to C₃₀ fatty acid, wherein the glycerol and/or polyglycerol has been alkoxylated with up to 30 mols of an alkylene oxide; and
applying a rinsing liquid to the textile.

21. A method as claimed in claim 20 wherein the rinsing liquid comprises water.

22. A method as claimed in claim 20 wherein the stain treatment additive is included in a textile cleaning composition comprising at least 10 wt % in total of one or more surfactants or mixtures thereof, not including the stain treatment additive.

23. (canceled)

24. (canceled)

25. A method as claimed in claim 20 wherein a stain on the textile which has been treated by the stain treatment additive has a delta Y value at least 10% higher than a stain treated with a stain remover composition or a laundry detergent composition of an equivalent formulation in which the ester has been replaced with water.

26. A method as claimed in claim 25 wherein the stain is selected from the group consisting of: coffee, dressing, oatmeal, chocolate, grass, olive oil, soot and mixtures thereof.
